(19) United States
(12) Patent Application Publication
(10) Pub. No.: US 2019/0005048 A1
(43) Pub. Date: Jan. 3, 2019

(54) OPTIMIZING MEDIA PRESENTATION WITHIN AN APPLICATION

(71) Applicant: Uber Technologies, Inc., San Francisco, CA (US)

(72) Inventors: Florent Crivello, San Francisco, CA (US); Ludovic Landry, San Francisco, CA (US)

(21) Appl. No.: 15/638,216

(22) Filed: Jun. 29, 2017

(51) Int. Cl. G06F 17/30; G09B 7/02; G06F 3/0484

(52) U.S. Cl. CPC G06F 17/30058; G06F 17/30867; G06F 3/0485; G09B 7/02; G06F 3/04842; G06F 17/30994

(57) ABSTRACT

A user device presents media to a user in the form of multiple content items, each comprising media components such as videos, text, and images. The user device uses user data and information about a set of content items accessed by the user to predict an order in which the user will access the content items. The user device requests, in the predicted order, media components associated with a number of content items to prepare the content items for presentation to the user. Responsive to detecting a transition between a presentation of a first content item and a presentation of a second content item, the user device may re-prioritize a predicted access order for the content items. The user device may additionally request media components to download according to quality levels. For example, a slow network connection may prompt a user device to use lower resolution video.

### BACKGROUND

### Field of Art

This disclosure relates generally to content delivery and display to a user device, and in particular to optimizing content delivery and display in view of user device context using a carousel format and preloading techniques.

### DESCRIPTION OF ART

Organizations can provide information and instructions about tasks and activities to users via user devices. For example, an organization may want to provide educational media to users to help the users learn how best to interact with the organization and associated systems. However, such media, including video, text, audio, and images, may take up large amounts of memory space and may include too much data to transmit reliably and quickly over some communications networks.

To transmit media to user devices, organizations must consider limitations related to bandwidth, memory usage, and latency. Especially in developing countries where data plans for personal computers and mobile devices often offer less than 200 MB per month, bandwidth usage may have a significant effect on media content a user can download to interact with or to view. Some user devices may additionally have prohibitive memory usage requirements. For example, older devices with less available space in memory may struggle to support memory intensive media formats such as videos. Furthermore, to help keep users engaged with the media, the organizations face issues related to latency. That is, when users want to view new content, it is important to have content that will be ready for them to view as soon as possible, so the users do not get bored and leave the platform.

### SUMMARY

To keep users engaged with an activity, lesson, or task, a user device presents content items to a user in a carousel format in a way that mitigates issues related to limited memory, limited bandwidth, and high latency. A content item may be a page or view of content. For example, a content item may comprise multiple media components (e.g., thumbnails, video, audio, text, etc.) delivered and displayed together to a screen of a smartphone. A user may initiate a transition between one content item and another by interacting with the user device, for example, by swiping sideways on a touchscreen. Dividing an activity or lesson into multiple content items helps to limit the amount of data that is stored in the memory of the user device and may spread out the number of times when data is retrieved over a network.

To save space in memory, the user device may limit the number of content items that it stores at one time. Presenting content items in a carousel format (e.g., in which a user pulls new content onto a touchscreen by swiping across the screen) means that a limited number of content items can be visible at the same time, for example, during a transition between two content items. For the purposes of this disclosure, an example of a carousel format wherein two content items may be displayed simultaneously is described. However, in other embodiments, more than two content items are visible (either partially or completely) at one time. For example, many small content items may be displayed for scrolling or selection, or the content items may be shown in a grid layout. Thus, the user device needs only enough memory to accommodate a limited number of content items, and can reuse the memory space as a subsequent content item is received.

A content server offers content items (and media components that make up the content items) at different quality levels. For example, a content server may store copies of a video at different resolutions. The user device can provide content despite limited bandwidth by determining conditions of a network by which it is connected to the content server and requesting media components at a quality level that can be transmitted over the network by the time it needs to be presented to a user. The user device may also request content items at lower quality levels when the user device has a limitation on an amount of data that can be used in a time period (e.g., a monthly data limit) to reduce costs associated with accessing content items.

In addition to addressing issues associated with memory usage and bandwidth, the user device avoids lag and other problems associated with high latency by anticipating which content item a user will access next and retrieving that content item from a content server before the user initiates a transition between content items. Additionally, the user device may prioritize retrieval of media components associated with a content item according to their attributes, such as according to file size. For example, a thumbnail image may be requested from a content server before a video so that the thumbnail can be delivered and displayed to a user as data for the video is still being downloaded to the user device from the content server.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram of an environment and an architecture for a user device, in accordance with some embodiments.

FIG. 2 is an example user interface illustrating media components associated with a content item, in accordance with an embodiment.

FIG. 3A is a sequence diagram showing a process for preparing a set of content items for delivery and display to a user, in accordance with an embodiment.

FIG. 3B is a sequence diagram showing a process for responding to a transition between currently presented content items, in accordance with an embodiment.

FIG. 4 is a flowchart showing a process for delivering and displaying content items to a user device, in accordance with an embodiment.

FIG. 5 is a block diagram illustrating components of an example machine able to read instructions from a machine-readable medium and execute them in one or more processors (or controllers), in accordance with an embodiment.

The figures depict an embodiment for purposes of illustration only. One skilled in the art will readily recognize from the following description that alternative embodiments of the structures and methods illustrated herein may be employed without departing from the principles of the embodiment described herein.

### DETAILED DESCRIPTION

A user device delivers media to a user as a set of content items. In some embodiments, each delivered content item may be viewed as an individual page or view of the content. For example, on a user device such as a smartphone, a user may be able to transition between views of different content items by performing an action such as swiping across a touch screen or selecting a widget that directs an application to the next content item. In some cases, a theme or lesson may be split into multiple content items that can be presented to a user individually, fostering a richer and more immersive media experience. Content items may additionally include multiple media components, such as videos, text, audio, and images, that can be displayed together (e.g., on a screen of a user device).

To address issues related to bandwidth, a content server serving content items to user devices may offer content at varying degrees of quality. For example, a video may be available for download at different resolutions. A user device can request media components at quality levels that are appropriate given a current network connection of the user device and given an amount of memory space a user device has available.

To reduce the amount of memory required for presenting content items to users, the user device may store a limited number of content items at one time. For example, on a smartphone a user may access different content items by swiping a screen. In that example case, at most two content items will be visible at once, e.g., when a first content item is halfway off the screen and half of a second content item has been pulled onto the screen. To limit memory usage, data about a content item that is not currently displayed may be replaced with data for a new content item. In addition to saving memory space, computing time may be reduced, in some embodiments, as transition between content items may include replacing displayed media components of one content item with media components of a next content item without a need to regenerate a whole page view for the next content item.

The user device includes a media preloader that predicts content items that a user is likely to view next using information such as which content item is currently being delivered and displayed to a user. This can reduce an amount of time a user has to wait for content to be presented by anticipating the next content item that a user is likely to access and preparing it for presentation before it is requested by the user. In some embodiments, the user device further addresses latency by requesting and receiving smaller media components (e.g., text, thumbnail images, etc.) before requesting videos, thus making it seem as though the page has most of its content as the user device completes the receipt of video data.

In addition to providing educational content to users in the form of video, text, and audio, the user device may facilitate other user interactions with the carousel format, such as flashcards, simulations (e.g., practice picking up users suggested by a ride-sharing system without actually picking up any users). The carousel format may also be used to present content items in flashcard format that switches between content items with questions and corresponding actions to help a user with memorization. In some embodiments, the user device can detect how fast a vehicle is going and stop providing content items for viewing by a user in case the user is driving.

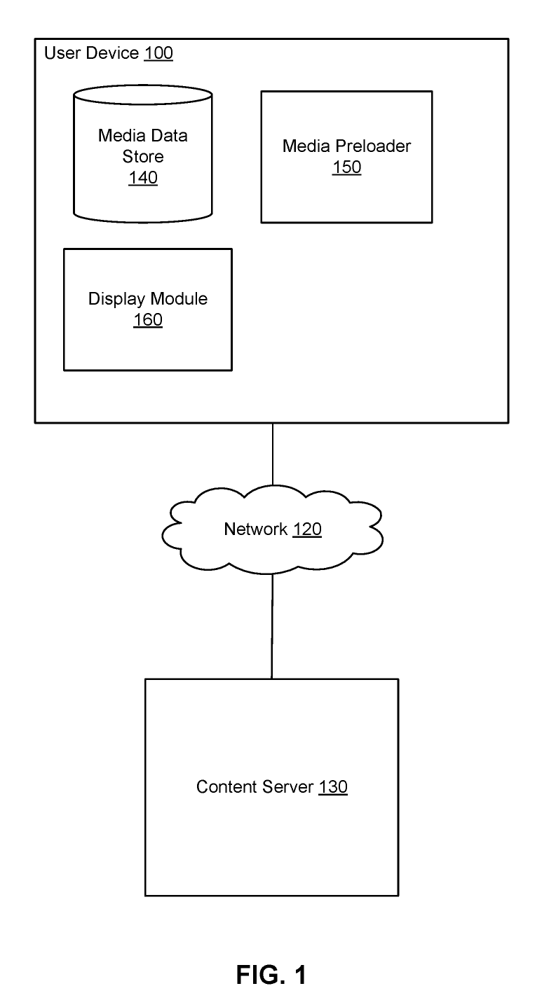

FIG. 1 is a block diagram of an environment and an architecture for a user device, in accordance with some embodiments. FIG. 1 includes a user device 100, a network 120, and a content server 130. For clarity, only one user device 100 is shown in FIG. 1. Alternate embodiments of the environment can have any number of user devices 100 as well as multiple content servers 130. The functions performed by the various entities of FIG. 1 may vary in different embodiments. The content server 130 may provide media (e.g., educational videos) to a user operating the user device 100. In some embodiments, applications running on the user device 100 may allow a user to switch between views containing different media.

The content server 130 provides media that user devices can access, for example by downloading the media content. In one embodiment, the content server 130 includes media that is relevant to different groups of users. For example, translated and alternate media may be available for users who speak different languages. The content server 130 may also store different content items that correspond to geographic or political regions. In some embodiments, the content server 130 may determine a region that is associated with a user profile of a user and provide content that is applicable in the determined region to the user device. In some embodiments, the content server 130 includes multiple versions of each piece of media at various quality levels. For example, a video may be available in low resolution and high resolution, the different video qualities taking up different amounts of memory space.

A user may interact with content, for example by watching video media and by reading textual media from the content server 130, through a user device 100. User devices 100 can be personal or mobile computing devices, such as smartphones, tablets, or notebook computers. In some embodiments, the user device 100 executes a client application that uses an application programming interface (API) to communicate with the content server 130 through the network 120.

User devices 100 may interact with the content server 130 through client applications configured to interact with the content server 130. The client applications of the user devices 100 can present information received from the content server 130 on a user interface, such as a map of the geographic region, a current location of the user device 100, and educational media. The client application running on the user device 100 may be able to determine the current location and provide the current location to the content server 130.

A user device 100 can communicate with the content server 130 via the network 120, which may comprise any combination of local area and wide area networks employing wired or wireless communication links. In one embodiment, the network 120 uses standard communications technologies and protocols. For example, the network 120 includes communication links using technologies such as Ethernet, 802.11, worldwide interoperability for microwave access (WiMAX), 3G, 4G, 4G LTE, code division multiple access (CDMA), digital subscriber line (DSL), etc. Examples of networking protocols used for communicating via the network 120 include multiprotocol label switching (MPLS), transmission control/protocol/Internet protocol (TCP/IP), hypertext transport protocol (HTTP), simple mail transfer protocol (SMTP), and file transfer protocol (FTP). Data exchanged over the network 120 may be represented using any format, such as hypertext markup language (HTML) or extensible markup language (XML). In some embodiments, all or some of the communication links of the network 120 may be encrypted.

In some embodiments, a user device 100 can detect changes in its connection to the content server 130 via the network 120. That is, a user device 100 can detect whether it is connected to the network 120 using Ethernet, 802.11, WiMAX, 3G, 4G, 4G LTE, CDMA, DSL, etc. For example, when a user leaves home, a user device 100 may switch from having a wifi network connection to having a 4G network connection, and the user device 100 can detect the change. The type of network 120 through which a user device 100 communicates with the content server 130 can affect how quickly data, such as media content items can be downloaded from the content server 130 by the user device 100.

The user device 100 includes various modules and data stores to determine a prioritization for requesting content items from the content server 130 and for delivering and displaying the content items to a user. The user device 100 comprises a media data store 140, a media preloader 150, and a display module 160. Computer components such as web servers, network interfaces, security functions, load balancers, failover servers, management and network operations consoles, and the like are not shown so as to not obscure the details of the architecture. Additionally, the user device 100 may contain more, fewer, or different components than those shown in FIG. 1 and the functionality of the components as described herein may be distributed differently from the description herein.

The media data store 140 stores local data related to content items that are received from the content server 130. An example of a content item is a page of an educational carousel that represents a portion of a lesson that is presented to a user. A content item may include one or more media components, such as text, videos, interactive activities, etc. The media data store 140 may store lists of content items and media components that are related to each other and which can be downloaded from the content server 130. In some embodiments, the media data store 140 may receive lists of content items and media components from the content server 130 when the user accesses a certain task, lesson, etc.

The media preloader 150 interacts with the content server 130 to receive media components when they are needed for delivering and displaying to the user device 100. In some embodiments, the media preloader 150 requests only a limited number of content items at one time, to save memory space. For example, in an application on a smartphone, content items may be accessed when a user swipes across the screen and pulls a new content item into view. In the example action of swiping one content item off of the display and pulling the next content item onto the display, at most, two content items will be visible at once. Thus, storing only two content items saves space in memory while also simulating an experience of having many content items to scroll through. When content that has been requested from the content server 130 by the media preloader 150 is downloaded to the user device 100, it may be stored at the media data store 140 to be accessed by the display module 160.

In some embodiments, the media preloader 150 prioritizes an order in which to request media components from the content server 130 using information about which media components associated with a content item will be needed first and which media components take the longest time to download from the content server 130. For example, the media preloader 150 may request text components and images associated with a content item before requesting video components associated with the same content item because video typically takes longer to download. In some embodiments, the media preloader 150 may predict an order in which a user is most likely to select or scroll to specific content items, or may predict a number of content items and associated media components that a user is likely to scroll through in a certain amount of time. For example, data about past user interactions with an application, past content items accessed by the user, a user's speed of transition between content items (e.g., swiping speed), or data about a default or recommended access order for content items may be used by the media preloader 150 to predict a prioritized ordering in which to request content items and their constituent media components from the content server 130. The media preloader 150 may begin receiving media components associated with a second content item while a user accesses and views a first content item. If a user initiates a transition to access a different content item, the media preloader 150 may predict a re-prioritized order in which the user may access the content items. Such a prediction may include information about the transition as input. Other inputs to a prediction algorithm may include a list of media components and a time series of past user actions. The media preloader 150 may pause the process of receiving media components that are currently being downloaded from the content server 130 if the currently downloading items are no longer predicted to be accessed in the near future.

As mentioned previously, the content server 130 stores multiple versions of content items and their associated media components. Specifically, the content server 130 may store different quality versions of the media components. When requesting media components from the content server 130, the media preloader 150 may select which version of a media component to download in view of the quality it will be best able to support. The media preloader 150 may select a quality level that allows media components to be transmitted from the content server 130 to the user device 100 on a current network connection of the user device 100. Similarly, the media preloader 150 may select a quality level at which to receive media components in view of an amount of available space the user device 100 has in memory. For example, if the user device 100 has a fast wife connection with a large amount of bandwidth and the user device 100 has enough available memory to store many videos at once, the media preloader 150 may request high quality media components, such as high-resolution images and videos. Conversely, if the user device 100 has a poor network connection and little available memory space, the media preloader may request lower quality media components which may take less time to download and less memory space to store due to having lower resolution. In some embodiments, the media preloader 150 may additionally analyze current video playback and media access speeds when determining which quality of media components to request from the content server 130. For example, if video playback is irregular or if media components take more time than was anticipated to download from the content server 130, the media preloader 150 may subsequently request lower quality media components.

The display module 160 manages the presentation of content items on the user device 100. In one embodiment, the display module 160 determines a maximum number of content items that will ever be visible at one time when content items are shown to the user (e.g., a particular layout may require more or fewer content items to be shown at once), and accordingly allocates an appropriate amount of memory to store data for the number of content items. The display module 160 accesses content items or media components associated with content items from the media data store 140 and presents them to the user. In some embodiments, the display module 160 detects user interactions with the user device 100. For example, the display module 160 may detect when a user initiates a transition between content items and sends information about the transition to the media preloader 150 so that the media preloader 150 may retrieve additional content items from the content server 130 if necessary.

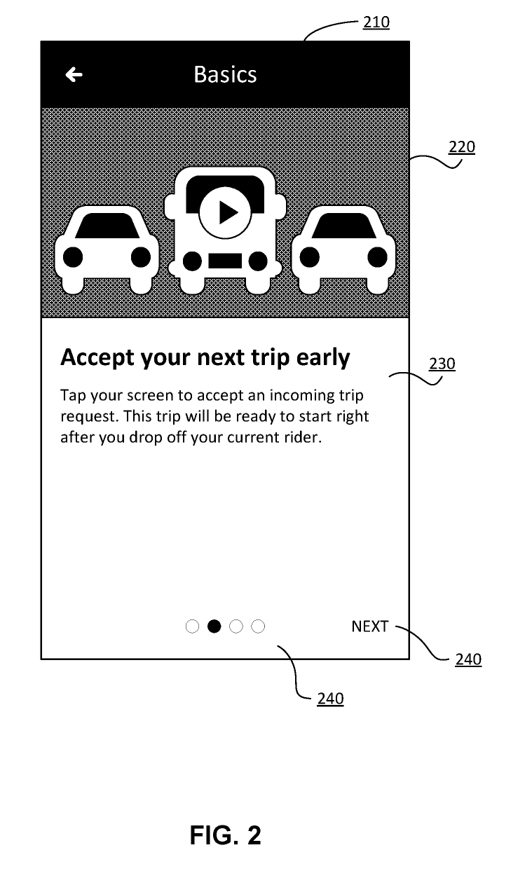

FIG. 2 is an example user interface illustrating media components associated with a content item, in accordance with an embodiment. The example of FIG. 2 shows a content item being delivered and displayed to a mobile interface 210, although it is appreciated that those of skill in the art will recognize other types of interfaces by which content items may be delivered and displayed. The interface 210 shows a content item comprising multiple media components including a video 220 and textual content 230. In the example of FIG. 2, a series of content items may be presented to teach a user who drives a vehicle for a ride-sharing service how to navigate to pick-up locations and how to accept trips most efficiently. The lesson may be made up of multiple sub-lessons, each represented by a content item, the content items being delivered and displayed as pages in a carousel format on the user device 100. Transition elements 240 may allow a user to transition between viewing different content items, for example, by swiping left or right on a touch screen or by selecting buttons.

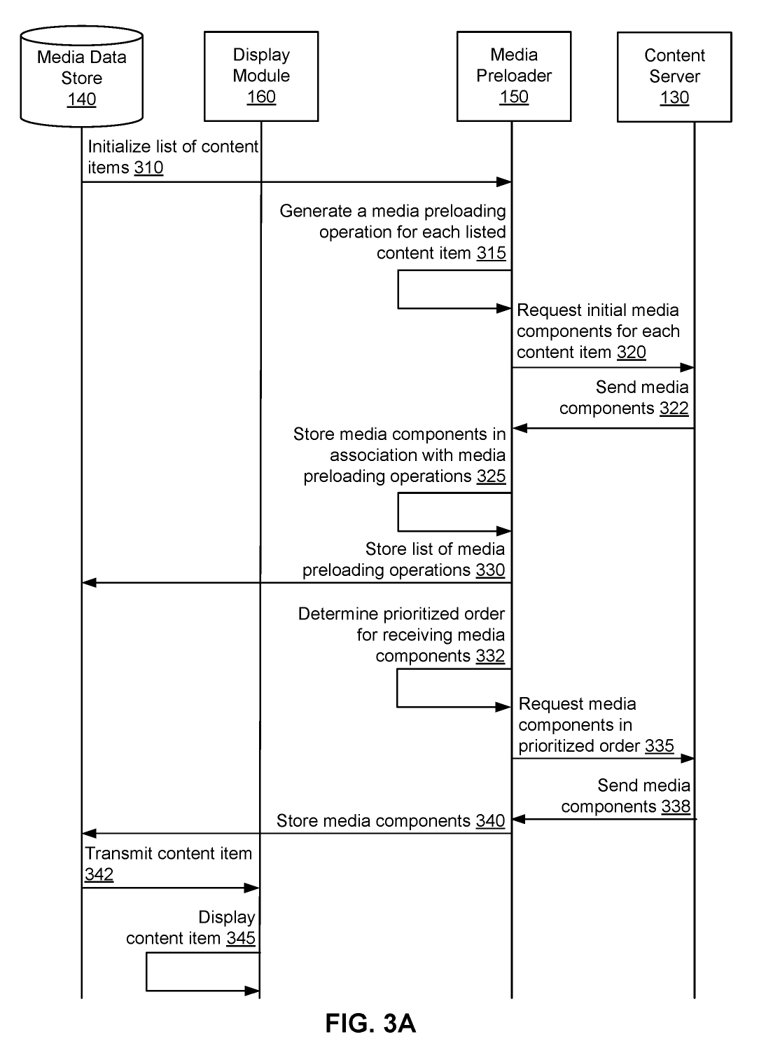

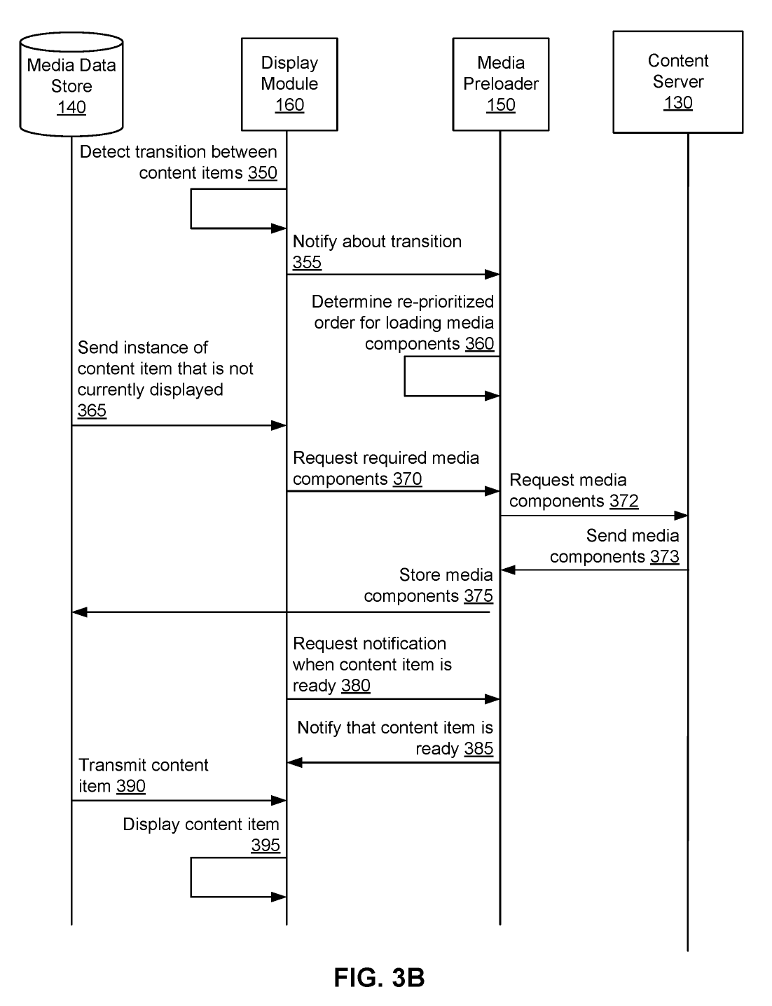

FIG. 3A is a sequence diagram showing a process for preparing a set of content items for delivery and display to a user, in accordance with an embodiment. Before the process begins, the display module 160 allocates memory space and any other necessary resources for a number of content items that the application supports for simultaneous display. For example, the display module 160 may prepare resources for presenting one content item to a user and for having a second content item standing by such that it is ready to be presented to the user. The media data store 140 initializes a list of content items 310 by sending information about the content items to the media preloader 150. The list of content items may include any information required to load the media components, as well as other information about how the data should be used by the display module 160. For example, the information may include data about the background color of a content item, whether a video should play automatically, whether a video should automatically repeat after completing, whether a user can interact with the display (e.g., skipping ahead in a video), etc. In one embodiment, the media data store 160 receives the list of available content items from the content server 130 when a user first accesses an application to view the content, and all media components and associated data are deleted from the media data store 140 when the user closes the application, for the purpose of saving memory. For each content item listed in the list of content items, the media preloader 150 generates, for each content item, a media loading operation 315 which requests the media components associated with the content item 320 from the content server 130. The content server sends the requested media components 322 to the media preloading operations on the media preloader 150. A media preloading operation handles interactions with the content server 130 to request media components for a particular content item. Each content item is stored by the media preloading operation 325 that it is associated with, and a list of media preloading operations is stored 330 by the media preloader 150 into the media data store 140. The media preloader may receive media components by requesting them at an appropriate quality level from the content server 130.

The media preloader 150 determines a prioritized order for receiving additional media components 332 associated with content items from the list of content items. To determine the prioritized order, the media preloader 150 predicts an order in which a user of the user device 100 will access the content items. The media preloader 150 may base such a prediction on a variety of factors such as which content items the user has viewed previously, a default or recommended order for viewing the content items, an order in which past users have accessed the content items, etc.

Once a prioritized order for receiving the media components is determined, the media preloader requests the additional media components from the content server 130 in the prioritized order 335, and the content server 130 sends the media components 338 to the user device 100. Media components are requested from the content server 130 at a quality level that is selected in view of capabilities of a current network connection of the user device 100 and the amount of available memory space in the media data store 140. The media components may be stored 340 in the media data store 140 as they are received from the content server 130. The media data store transmits the first content item 342 to the display module 160 and the display module 160 delivers and displays the content item 345.

FIG. 3B is a sequence diagram showing a process for responding to a transition between currently presented content items, in accordance with an embodiment. When a user of a user device 100 is viewing a content item and initiates a transition to a different content item, the display module 160 detects a transition between the content items 350. The display module 160 notifies the media preloader 150 about the transition 355. The media preloader 150 determines a re-prioritized order for receiving the media components 360 from the content server 130. For example, if a user transitions between content items by skipping past several intermediate content items in a recommended sequence of content items, then the media preloader may determine that the skipped content items no longer need to be as highly prioritized since the user may not try to access them.

The media data store 140 sends instances of the content item that is not currently displayed 365 by the display module 160 to the display module 160 for presentation to the user. The display module 160 may additionally request that the media preloader 150 retrieve additional required media components 370 from the content server 130, for example, if the content item accessed by the user had not yet been stored in the media data store 140 from the content server 130. In such cases, the media preloader 150 requests the required media components 372 from the content server 130 and the content server 130 sends the media components 373 to the media preloader 150. In some embodiments, the media preloader 150 stores the received media components 375 from the content server 130 in the media data store 140.

In some embodiments, the display module 160 may request a notification about when a content item is ready 380 to be presented to the user, such as when at least one media component associated with the content item has been received from the content server 130. The media loading operation managing that content item on the media preloader 150 may notify the display module 160 when the content item is ready 385 to be presented to a user. When the new content item is ready for presentation, the media data store 140 may transmit the content item 390 to the display module 160 and the display module 160 may begin to display the content item 395.

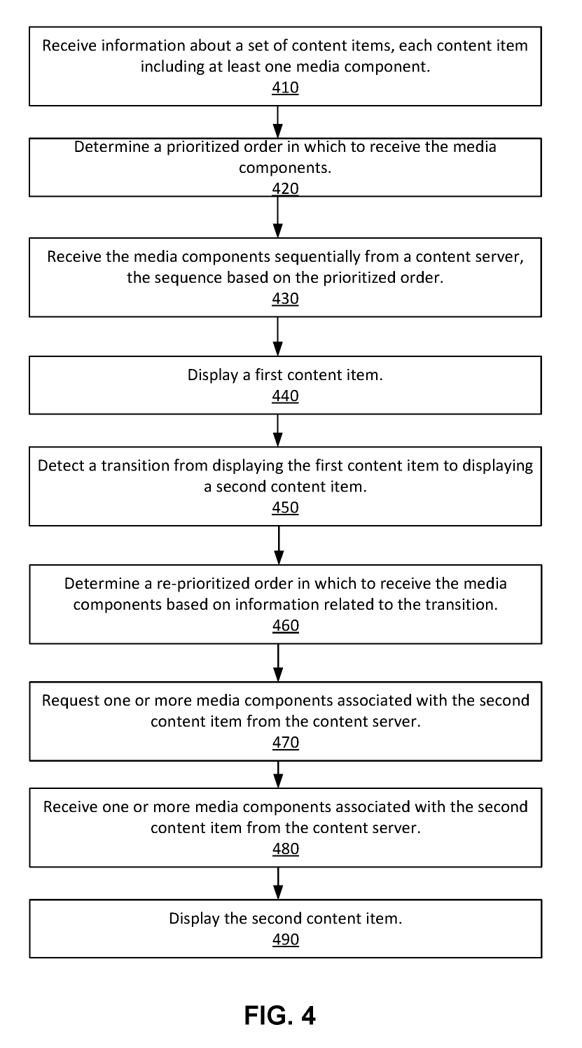

FIG. 4 is a flowchart showing a process for delivering and displaying content items to a user device, in accordance with an embodiment. The user device 100 receives information about a set of content items, each content item including at least one media component 410. The user device 100 determines a prioritized order in which to receive the media components 420. The user device 100 sequentially receives the media components from a content server 430, such as the content server 130. The media components are requested in the determined prioritized order.

The user device 100 displays a first content item 440, for example, by presenting the media components that are associated with the content item on a screen of the user device 100. The user device 100 detects a transition from displaying the first content item to displaying a second content item 450. For example, if the user device 100 is a smartphone, the user device 100 may detect a transition when a user swipes left or right on the screen to view different content items. When a transition between content items is detected, the user device 100 determines a re-prioritized order in which to receive the media components 460.

The user device 100 requests one or more media components associated with the second media content item from the content server 470 and receives the one or more media components associated with the second content item from the content server 480. The user device 100 then displays the second content item 490.

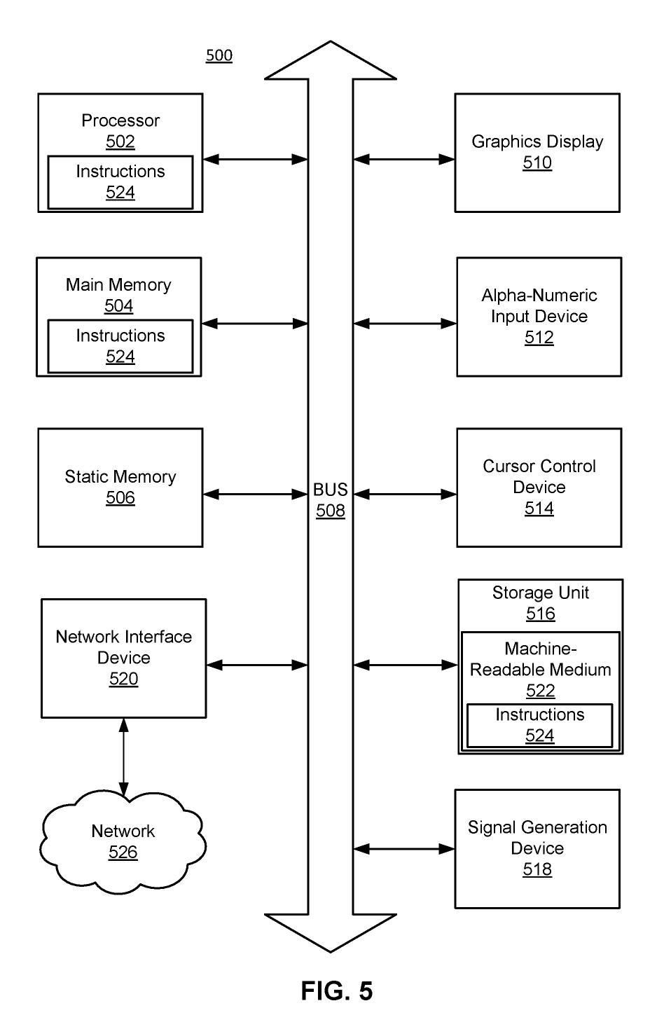

FIG. 5 is a block diagram illustrating components of an example machine able to read instructions from a machine-readable medium and execute them in one or more processors (or controllers). Specifically, FIG. 5 shows a diagrammatic representation of content server 130 in the example form of a computer system 500. The computer system 500 can be used to execute instructions 524 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes one or more processing units (generally processor 502). The processor 502 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 500 also includes a main memory 504. The computer system may include a storage unit 516. The processor 502, memory 504, and the storage unit 516 communicate via a bus 508.

In addition, the computer system 500 can include a static memory 506, a graphics display 510 (e.g., to drive a plasma display panel (PDP), a liquid crystal display (LCD), or a projector). The computer system 500 may also include alphanumeric input device 512 (e.g., a keyboard), a cursor control device 514 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. For example, the instructions 524 may include instructions for implementing the functionalities of the media preloader 150 and the display module 160. The instructions 524 may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store the instructions 524. The term “machine-readable medium” shall also be taken to include any medium that is capable of storing instructions 524 for execution by the machine and that cause the machine to perform any one or more of the methodologies disclosed herein. The term “machine-readable medium” includes, but not be limited to, data repositories in the form of solid-state memories, optical media, and magnetic media.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by one or more computer processors for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method performed by a user device, comprising:
receiving, by at least one processor, information about a set of content items to be displayed by the user device, each content item comprising one or more media components;
generating a prioritized order in which to receive one or more media components associated with the set of content items;
requesting one or more media components from a content server and, as the requested one or more media components are received from the content server, sequentially preparing the received one or more media components for delivery to the user, the sequence based on the prioritized order;
displaying a first content item from the set of content items on the user device;
detecting information about a transition from displaying the first content item to displaying a second content item from the set of content items;
generating a re-prioritized order for receiving the media components, the re-prioritized order based, at least in part, on the information about the transition;
requesting, from the content server, one or more media components associated with the second content item;
receiving the one or more media components associated with the second content item from the content server and sequentially preparing the received one or more media components associated with the second content item for delivery to the user, the sequence based on the re-prioritized order; and
displaying the second content item from the set of content items on the user device.

2. The computer-implemented method of claim 1, wherein requesting one or more media components associated with a content item from the content server comprises:
determining a connection type by which the user device is connected to a network;
determining a media component quality level that can be supported by the connection type; and
requesting the one or more media components in the determined quality level to be transmitted over the network from the content server.

3. The computer-implemented method of claim 2, wherein determining a media component quality level that can be supported by the connection comprises:
determining an available bandwidth for receiving the content from the content server; and
selecting a version of the content item that is available on the content server and that can be received using the determined available bandwidth.

4. The computer-implemented method of claim 1, wherein types of media components that are associated with content items include at least one or more of images, audio, or video.

5. The computer-implemented method of claim 1, wherein the re-prioritized order for receiving media components is based in part on a speed at which a user of the user device transitions between displaying different content items on the user device.

6. The computer-implemented method of claim 1, wherein generating a prioritized order in which to receive one or more media components associated with the set of content items comprises predicting an order in which a user is most likely to navigate to specific content items from the set of content items, the prediction based on historical user interactions with the user device.

7. The computer-implemented method of claim 1, wherein displaying a content item comprises:
displaying a first media component associated with the content item; and
responsive to receiving one or more subsequent media components associated with the content item from the content server:
displaying the one or more subsequent media components.

8. The computer-implemented method of claim 1, wherein receiving media components from the content server comprises receiving media components associated with a pre-determined number of content items, and, responsive to receiving media components associated with a newly requested content item, allocating memory space of a previously received content item to store the media components associated with the newly requested content item.

9. The computer-implemented method of claim 1, wherein a transition from displaying a first content item to displaying a second content item is initiated by a user of the user device.

10. A non-transitory computer-readable storage medium storing computer program instructions executable by one or more processors of a system to perform steps comprising:
receiving, by at least one processor, information about a set of content items to be displayed by the user device, each content item comprising one or more media components;
generating a prioritized order in which to receive one or more media components associated with the set of content items;
requesting one or more media components from a content server and, as the requested one or more media components are received from the content server, sequentially preparing the received one or more media components for delivery to the user, the sequence based on the prioritized order;
displaying a first content item from the set of content items on the user device;
detecting information about a transition from displaying the first content item to displaying a second content item from the set of content items;
generating a re-prioritized order for receiving the media components, the re-prioritized order based, at least in part, on the information about the transition;
requesting, from the content server, one or more media components associated with the second content item;
receiving the one or more media components associated with the second content item from the content server and sequentially preparing the received one or more media components associated with the second content item for delivery to the user, the sequence based on the re-prioritized order; and
displaying the second content item from the set of content items on the user device.

11. The non-transitory computer-readable storage medium of claim 10, wherein requesting one or more media components associated with a content item from the content server comprises:
determining a connection type by which the user device is connected to a network;
determining a media component quality level that can be supported by the connection; and
requesting the one or more media components in the determined quality level to be transmitted over the network from the content server.

12. The non-transitory computer-readable storage medium of claim 10, wherein types of media components that are associated with content items include at least one or more of images, audio, or video.

13. The non-transitory computer-readable storage medium of claim 12, wherein determining a media component quality level that can be supported by the connection comprises:
determining an available bandwidth for receiving the content from the content server; and
selecting a version of the content item that is available on the content server and that can be received using the determined available bandwidth.

14. The non-transitory computer-readable storage medium of claim 10, wherein the re-prioritized order for receiving media components is based in part on a speed at which a user of the user device transitions between displaying different content items on the user device.

15. The non-transitory computer-readable storage medium of claim 10, wherein generating a prioritized order in which to receive one or more media components associated with the set of content items comprises predicting an order in which a user is most likely to navigate to specific content items from the set of content items, the prediction based on historical user interactions with the user device.

16. The non-transitory computer-readable storage medium of claim 10, wherein displaying a content item comprises:
displaying a first media component associated with the content item; and
responsive to receiving one or more subsequent media components associated with the content item from the content server:
displaying the one or more subsequent media components.

17. The non-transitory computer-readable storage medium of claim 10, wherein receiving media components from the content server comprises receiving media components associated with a pre-determined number of content items, and, responsive to receiving media components associated with a newly requested content item, allocating memory space of a previously received content item to store the media components associated with the newly requested content item.

18. The non-transitory computer-readable storage medium of claim 10, wherein a transition from displaying a first content item to displaying a second content item is initiated by a user of the user device.

19. A computer system comprising:
one or more computer processors for executing computer program instructions; and
a non-transitory computer-readable storage medium storing instructions executable by the one or more computer processors to perform steps comprising:
receiving, by at least one processor, information about a set of content items to be displayed by the user device, each content item comprising one or more media components;
generating a prioritized order in which to receive one or more media components associated with the set of content items;
requesting one or more media components from a content server and, as the requested one or more media components are received from the content server, sequentially preparing the received one or more media components for delivery to the user, the sequence based on the prioritized order;
displaying a first content item from the set of content items on the user device;
detecting information about a transition from displaying the first content item to displaying a second content item from the set of content items;
generating a re-prioritized order for receiving the media components, the re-prioritized order based, at least in part, on the information about the transition;
requesting, from the content server, one or more media components associated with the second content item;
receiving the one or more media components associated with the second content item from the content server and sequentially preparing the received one or more media components associated with the second content item for delivery to the user, the sequence based on the re-prioritized order; and
displaying the second content item from the set of content items on the user device.

20. The computer system of claim 19, wherein requesting one or more media components associated with a content item from the content server comprises:
determining a connection type by which the user device is connected to a network;
determining a media component quality level that can be supported by the connection; and
requesting the one or more media components in the determined quality level to be transmitted over the network from the content server.
